(19) United States
(12) Patent Application Publication
(10) Pub. No.: US 2008/0281468 A1
(43) Pub. Date: Nov. 13, 2008

(54) VARIABLE PRIMITIVE MAPPING FOR A ROBOTIC CRAWLER

(75) Inventors: Stephen C. Jacobsen, Salt Lake City, UT (US); Marc Olivier, Sandy, UT (US); Ralph W. Pensel, Sandy, UT (US); Christopher R. Hirschi, Salt Lake City, UT (US)

Correspondence Address: THORPE NORTH & WESTERN, LLP., P.O. Box 1219, SANDY, UT, 84091-1219, US

(73) Assignee: RAYTHEON SARCOS, LLC, Waltham, MA (US)

(21) Appl. No.: 12/117,233

(22) Filed: May 8, 2008

Related U.S. Application Data
(60) Provisional application No. 60/928,483, filed on May 8, 2007.

(51) Int. Cl. B25J 9/00

(52) U.S. Cl. 700/246; 700/257; 901/1

(57) ABSTRACT

Varying modes of movement of a robotic crawler are provided by using a variable mapping from high-level (operator input) primitives into low-level primitives. The mapping is a function of environmental data sensed by the robotic crawler enabling the movement mode to be adapted to the environment.

### RELATED APPLICATIONS

This application claims the benefit of U.S. Provisional Patent Application No. 60/928,483, filed May 8, 2007 in the United States Patent and Trademark Office, and entitled, “Variable Primitive Mapping For A Robotic Crawler,” which application is incorporated by reference in its entirety herein.

This application further incorporates herein by reference commonly-owned and co-pending U.S. patent application Ser. No. 11/985,323, entitled “Serpentine Robotic Crawler,” and U.S. patent application Ser. No. 11/985,336, entitled “Tracked Robotic Crawler Having a Moveable Arm,” both filed on Nov. 13, 2007.

### FIELD OF THE INVENTION

The present invention relates to the control of robotic devices capable of movement.

### BACKGROUND OF THE INVENTION AND RELATED ART

Research in robotics has resulted in a plethora of different robot configurations. A particularly interesting area of robotics is robotic devices that can move, referred to generally as robotic vehicles or robotic crawlers. Some robotic crawler are quite versatile, enabling a number of tasks to be performed.

Control of a complex robotic crawler can be quite challenging when there are many joints, motors, etc. to be coordinated. One control approach is the so-called “replica master” mode of operation. The robot is slaved to a replica master, which provides the same joints and actuators as the robot. As the operator manipulates the master, the master communicates positions of joints and actuators to robot, which attempts to move to the same position. While the replica master mode is handy for some types of robot manipulation (e.g., telemanipulation), this type of control can be a tedious way to navigate a robot through a varied terrain. Control is slow, as it puts the human operator within the control loop, making rapid response to environmental changes difficult to achieve. In addition, for very complex robotic crawlers, the number of joints to be controlled can be impractical to manage with replica master control.

Consequently, control of movement in complex robotic crawlers is often preprogrammed to establish a pattern of movement. Activation of joints and motors is coordinated according to predefined formulas or relationships to produce a specified movement mode or gait for the robotic crawler. Operator controls are typically limited to a few high level inputs into the preprogrammed movement, such as direction and speed. While such a control approach makes the operator's job much easier, it is at the cost of reduced capability for the robotic crawler. Typically, each additional function or capability provided by the robotic crawler involves the addition of controls that the operator will learn to operate to use the robotic crawler. With more controls to operate, the operator tends to be slower to respond to environmental changes, in turn limiting the robotic crawler's agility.

### SUMMARY OF THE INVENTION

The present invention includes a method and system for varying the character of movement of a robotic crawler. In one embodiment, a method of varying the character of movement of the robotic crawler includes defining a plurality of low-level primitives to control basic movements of the robotic crawler. A high-level primitive, accepted from an operator, is mapped into a variable set of low-level primitives for execution by the robotic crawler to produce varying modes of movement. The mapping can be a function of environmental data sensed by the robotic crawler. The robotic crawler executes the variable set of low-level primitives to move the robotic crawler.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention, they are, therefore, not to be considered limiting of its scope. It will be readily appreciated that the components of the present invention, as generally described and illustrated in the figures herein, can be arranged and designed in a wide variety of different configurations. Nonetheless, the invention will be described and explained with additional specificity and detail through the use of the accompanying drawings in which:

FIG. 1(a)-FIG. 1(d) are perspective illustrations of a robotic crawler in various poses according to an exemplary embodiment of the present invention;

FIG. 2 is a block diagram of a robotic crawler control system in accordance with an embodiment of the present invention;

FIG. 3 is a block diagram of a primitive hierarchy in accordance with an embodiment of the present invention;

FIG. 4 is a block diagram of a robotic crawler control system in accordance with another embodiment of the present invention; and

FIG. 5 illustrates a flow chart of a method of varying character of movement of a robotic crawler within an environment in accordance with an embodiment of the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation: to describe the features and characteristics of the present invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by reference numbers throughout. Like reference numbers and designations in the drawings indicate like elements providing similar functionality. A letter after a reference designator number represents an instance of an element having the reference designator number

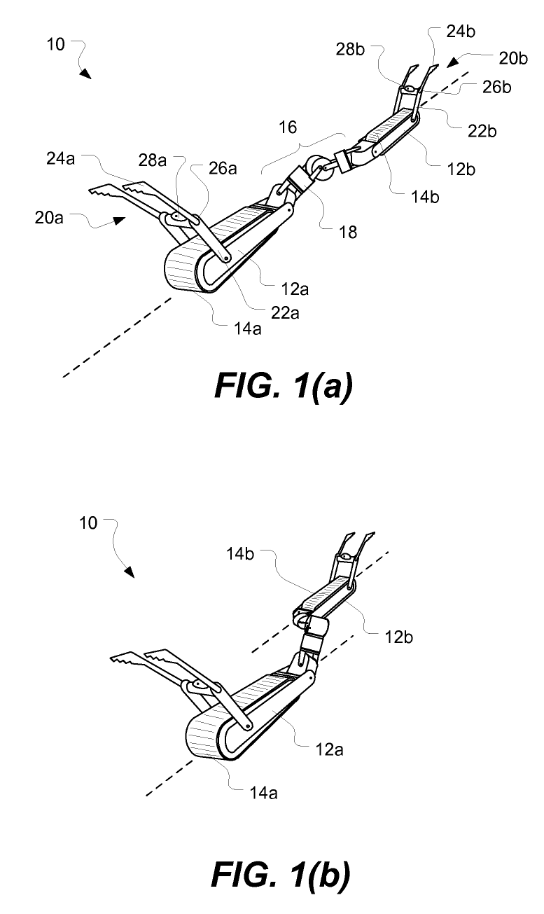

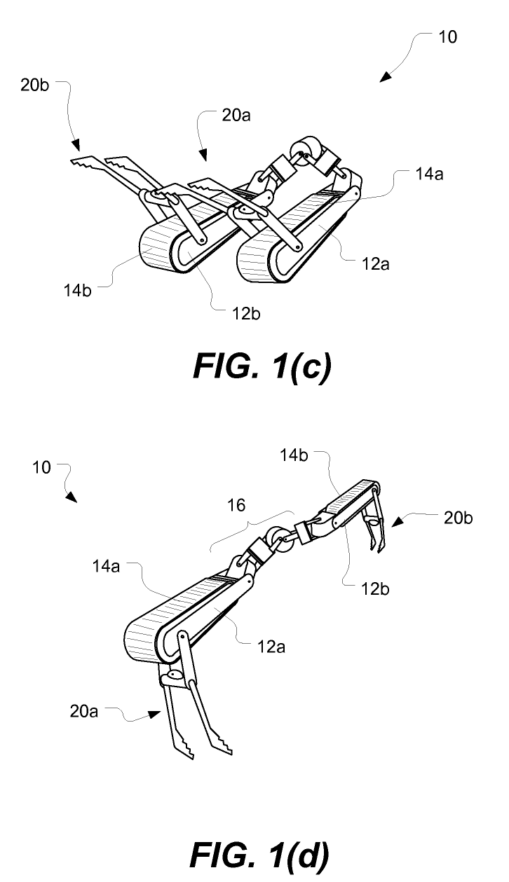

With reference to FIG. 1(a)-FIG. 1(d), shown is an illustration of a robotic crawler in accordance with one embodiment of the present invention. While the illustrated crawler is a ground crawler, it will be appreciated that embodiments of the present invention are not limited to ground operated crawlers, and can be applied to robotic crawlers operating in other environments. The robotic crawler, shown generally at 10, includes two frames 12a, 12b, each having a track 14a, 14b. The frames are coupled together through a multiple degree of freedom linkage arm 16 have a plurality of joints 18. Coupled to the frames are jointed arms 20a, 20b, each having a first arm segment 22a, 22b and a second arm segment 24a, 24b. The arm segments are coupled with an arm joint 26a, 26b. Each jointed arm can include a sensor 28a, 28b.

The robotic crawler 10 is capable of a variety of movement modes. For example, the frames 12a, 12b can be configured in a “train” pose as illustrated in FIG. 1(a) where the frames are approximately aligned in the same direction. In the train pose, forward and backward movement can be achieved by operating the tracks 14a, 14b so they move in the same relative direction.

The multi-degree of freedom linkage arm 16 can be configured to provide a sideways offset of the frames 12a, 12b to place the robotic crawler 10 in a “zag” pose, as illustrated in FIG. 1(b). The zag pose provides increased lateral stability, for example, while traversing or climbing a hill. Movement can be provided by rotation of the tracks 14a, 14b in the same way as for when in the train pose.

An alternate movement mode is possible when in the “tank” pose shown in FIG. 1(c) where the frames 12a, 12b are positioned side by side. The robotic crawler 10 can be moved in a forward and reserve direction by driving the tracks 14a, 14b in the same relative direction. The robotic crawler can be turned by driving the continuous tracks differentially (at different rates or even in different directions). In general, moving the robotic crawler in the tank pose can involve applying different drive speeds and directions to the tracks. The direction sense of one of the tracks is reversed when in the tank pose relative to direction when in the train pose.

Other movement modes for the robotic crawler 10 are also possible. For example, rotation of the tracks 14a, 14b can be combined with actuation of the jointed arms 20a, 20b. For example the leading arm 20a can lift the end of the leading frame 12a up to clear an obstacle, climb a step, or enter a raised hole. As another example, the jointed arms 20a, 20b can be rotated to provide a swimming or hopping like motion to the robotic crawler.

Yet another movement mode is possible when in the “standing” pose illustrated in FIG. 1(d) where the jointed arms 20a, 20b are rotated underneath the robotic crawler 10 to function as legs. Accordingly, movement can include various four-legged gaits, including for example, walk, trot, cantor, gallop, bound, and pronk. Four-legged gaits can be described in part in terms of the relative phase relationships of the leg movements. For example, in walk, one leg at a time is moved in succession (e.g., left front, right hind, right front and left hind, with phase lags of 0.25 cycles between each movement). Trot, cantor, and gallop mirror movement modes in four legged animals, for example, horses. Bound is where the front legs move together and the rear legs move together. Pronk is where all four legs move together, for example, producing a hopping motion.

Other movement modes may also be implemented which combine actuation of the jointed arms 20a, 20b and the tracks 14a, 14b, or combine actuation of the jointed arms, tracks, and the multi-degree of freedom linkage arm 16. For example, movement modes can include undulating caterpillar or inchworm like movement, hopping type movements, slithering type movements, etc. As another example, the robotic crawler 10 is capable of operating on either horizontal or vertical surfaces. For example, by wrapping itself around a vertical pole, the robotic crawler can provide sufficient traction forces to move up and down the vertical surface.

The most advantageous movement mode to use will vary depending on the terrain in which the robotic crawler is operating. Different movement modes may produce differing stability, traction, efficiency, and energy usage. Attempting to produce a wide variety of movement modes with a replica master, while possible, is tedious and slow. Conversely, while programming several different movement modes is possible, switching between movement modes, starting, stopping, and turning can be complex operations that vary depending on the various movement modes. For example, as noted above, forward movement in the train pose requires rotating the tracks in different directions than when in the tank pose. Moreover, control of the different movement modes is often different. For example, as noted above, when in the tank pose differential rates of rotation of the tracks causes the robotic crawler to turn, while in the train pose, actuation of the multi-degree of freedom linkage arm causes the robotic crawler to turn.

Accordingly, the robotic crawler can automatically adapt the movement mode to a changing environment. Movement modes of the robotic crawler can be controlled using a hierarchical set of primitives. Low-level primitives can be defined for basic functions, such as turning tracks, rotating arms, etc. High-level primitives can be built up from the low-level primitives, to execute complex, coordinated movements and behavior, for example, tank movement, four-legged walk, etc. High-level primitives may correspond to operator input commands, for example, move forward, stop, navigate toward a particular point, etc. High-level primitives can be executed by executing the low-level primitives mapped to the high-level primitive. Executing the low-level primitives causes the robotic crawler to move.

The mapping of high-level primitives into low-level primitives may be variable. For example, the mapping may be varied in response to environmental conditions sensed by the robotic crawler to adapt movement mode of the robotic crawler to the environment. Variable mapping enables the robotic crawler to switch from a first movement mode optimized for a first environment to a second movement mode optimized for a second, topologically different environment when the robotic crawler moves from the first environment into the second environment. By changing the mapping between high-level primitives and low-level primitives, the interface to the high-level primitives can be held constant, independent of the environment or movement mode being executed. This can help to provide a simpler, more intuitive operator control, which operates more consistently even though the underlying movement mode of the robotic crawler is changing.

The movement mode can be automatically selected based on the environmental data sensed by the robotic crawler. For instance, the selection of the movement mode can be based on the environmental data using a predefined association of movement modes to particular environmental conditions. The robotic crawler can also be configured to adaptively vary the movement mode when the environmental data indicates undesired conditions.

Consider an example where the robotic crawler is to travel through three different environments: an uneven field, tangled vegetation, and a hard surface. For crossing the uneven field, the tank configuration may be used due to the stability and traction provided. Upon encountering the tangled vegetation, the train configuration may be used due to the reduced cross sectional profile reducing the risk of becoming hung up in the vegetation. Finally, for the hard surface, a four-legged movement mode may be used to increased speed. Each of these movement modes is implemented using a different set of low-level primitives. High-level primitives for “move forward” and “turn” therefore map to different low-level primitives. The mapping is changed as the robotic crawler moves from one environment to the next.

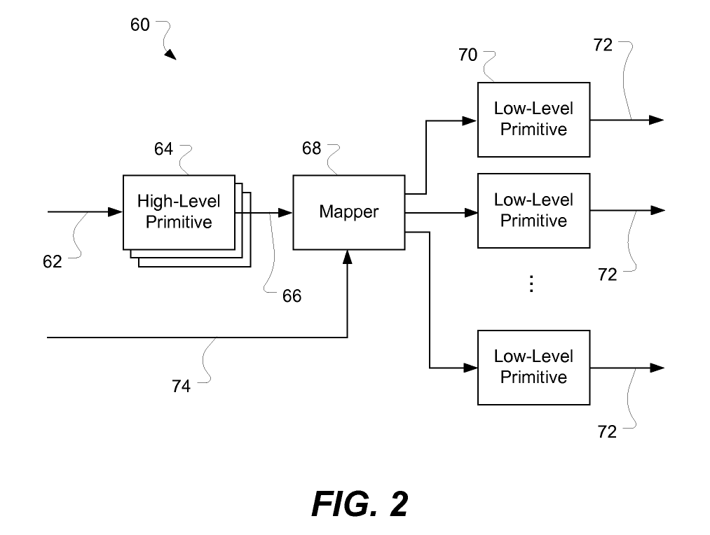

For example, FIG. 2 illustrates a block diagram of robotic crawler control system in accordance with an embodiment of the present invention. The robotic crawler control system 60 accepts an operator input 62 to one or more high-level primitives 64 to control movement of the robotic crawler. As mentioned above, various high-level primitives can be included to control direction of movement, speed of movement, pose, type of movement, etc. The high-level primitives can also accept operator input to control operation of the primitive, such as for example, throttle settings, steering wheel position, etc. The high-level primitive provides control outputs 66 to a mapper 68 that maps the high-level primitive into a variable set of low-level primitives 70. The low-level primitives provide drive outputs 72 to control actuators, motors, or the like within the robotic crawler to move the robotic crawler.

The mapper 68 accepts sensor input 74, which is used to determine how to map the high-level primitives 64 into a variable set of low-level primitives 70. For example, the sensor data may be processed to determine a type of environment in which the robotic crawler is operating. Based on the environment, a movement mode can then be selected. Based on the movement mode, different sets of low-level primitives can be executed to place the robotic crawler into the proper pose and to implement the selected movement mode.

As a specific example, an operator control console can include a joystick to generate operator input for control of direction and speed of movement. Joystick control can be intuitive, with movement of the joystick forward and backwards corresponding to forward and backward motion of the robotic crawler, and side to side motions corresponding to turning. How operator movements of the joystick map into detailed movements of the robotic crawler is a complex function of the movement mode currently in use by the robotic crawler. Note that more than one high-level primitive may be active at a time, for example, pushing the joystick both forward and sideways can result in forward motion and turning simultaneously.

In the tank mode, movement of the joystick forward or backwards provides input to a high-level “move” primitive, and is mapped into low-level primitives for driving the tracks forward and backwards (relative to the line of travel). Movement of the joystick left or right is input to a high-level “turn” primitive, and is mapped into low-level primitives that drive the tracks differentially to cause the robotic crawler to turn. In the train mode, “move” is mapped into primitives for driving the tracks forward and backwards (as noted above, different rotational directions than when in the tank mode) and “turn” is mapped into primitives that actuate the multi-degree of freedom linkage arm to bend the shape of the robotic crawler to effect the turn. In four-legged mode, “move” is mapped into primitives that control operation of the jointed arms and “turn” is mapped either to primitives that control actuation of the multi-degree of freedom linkage arm or to primitives that control differential movement of the jointed arms. Table 1 provides a summary of the above example according to an embodiment of the present invention.

TABLE 1
Summary of Mapping for Different Movement Modes

| | | Primitive “Move” | Primitive “Turn” |
|---|---|---|---|
| Environment | Pose | Mapping | Mapping |
| uneven field | tank | drive tracks | drive tracks |
| tangled vegetation | train | drive tracks | actuate linkage arm |
| hard surface | standing | drive arms | actuate linkage arm |

While the preceding example is somewhat simplified for illustration purposes, it should be appreciated that a large number of primitives and variable mappings may be used for the robotic crawler. Primitives may be defined for both simple and complex actions. For example, primitives may be defined to control individual motors or actuators. As another example, primitives may be defined which control multiple motors or actuators in a coordinated way making use of other primitives. Primitives may be defined to place the robotic crawler into particular poses or to implement particular movement modes or gaits.

Although described herein in terms of low-level primitives and high-level primitives, the hierarchy of primitives can include 2, 3 or more levels of primitives, ranging from lowest-level basic primitives (e.g., operating individual actuators or motors), to mid-level primitives, to very-high-level primitives (e.g., execute a predefined mission). Moreover, it should be appreciated that the primitives do not need to follow a strict hierarchy, in that a primitive may rely on several other primitives from different levels in the hierarchy. The primitive hierarchy may be defined so that some low-level primitives can only be accessed through mid-level primitives, while other low-level primitives can be accessed from either mid-level or high-level primitives.

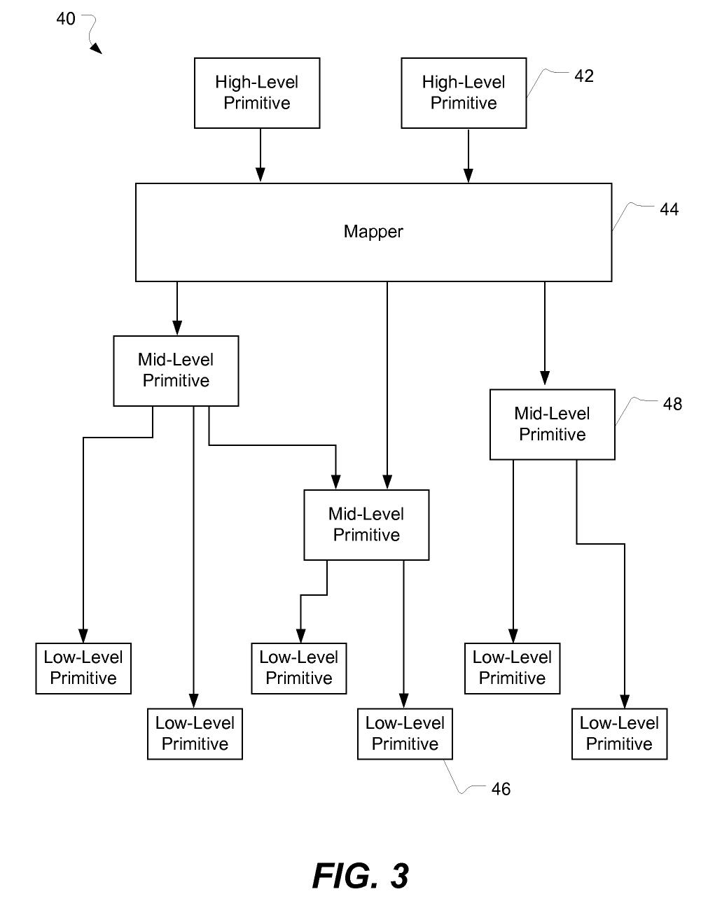

For example, FIG. 3 illustrates a block diagram of a primitive hierarchy 40 in accordance with an embodiment of the present invention. In the primitive hierarchy, high-level primitives 42 are mapped by the mapper 44 into mid-level primitives 48, which in turn map into low-level primitives 46. For example, mid-level primitives may define pose, traction, drive mode, etc., which are in turn translated into detailed low-level primitives. Various other arrangements, including additional levels of primitives, and additional mappers at more than one position within the hierarchy may also be used in embodiments of the present invention.

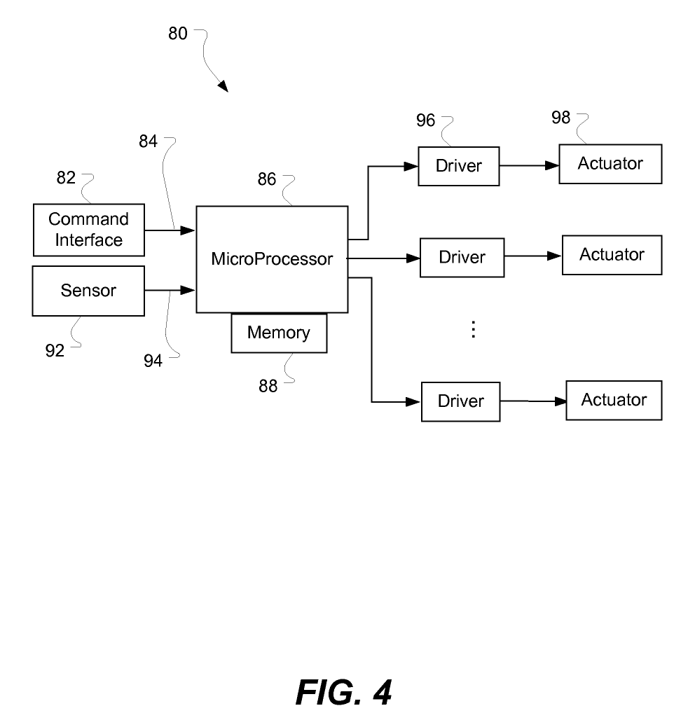

A robotic crawler control system can be implemented using a microprocessor (or microcontroller) as illustrated in block diagram form in FIG. 4 in accordance with an embodiment of the present invention. The robotic crawler control system 80 includes a means, such as a command interface 82, for accepting from an operator a high-level primitive 84 to be performed by the robotic crawler. The command interface may, for example, be a wired or wireless link to an operator control console (not shown). The high-level primitive commands can be provided to the microprocessor 86. The robotic crawler can also include means for sensing the environment, such as a sensor 92 which provides environmental data 94 to the microprocessor. Various types of sensors 92 can be used including, for example, a camera, a chemical sensor, a biological sensor, an optical sensor, a moisture sensor, a vibration sensor, a temperature sensor, an electromagnetic sensor, a sound sensor, a force sensor, a sonar sensor, a radar sensor, a lidar sensor, a radioactive isotope sensor, a seismic sensor, a pressure sensor, a magnetometer, a sampling sensor, an orientation sensor, an inertial measurement unit, a joint torque sensor, a joint position sensor, combinations of sensors, or multiple sensors. Outputs of sensors provide environmental data 94, for example, in a computer-readable format, describing characteristics of the actual real-world environment in which the robotic crawler is operating.

The robotic crawler control system 80 can include means for mapping the high-level primitives into a variable set of low-level primitives for execution by the robotic crawler, for example, software instructions for the microprocessor 86 stored in memory 88. The memory may be part of the microprocessor or external to the microprocessor. Various types of memories may be used, including for example, read only memory, programmable read only memory, random access memory, and the like.

The mapping from high-level primitives into a variable set of low-level primitives can be a function of the environmental data 94. For example, the sensor data may be processed to recognize an environmental condition and then an optimal movement mode selected for the particular environmental conditions. Selections may be, for example, based on predefined determination of movement modes optimized for differing environmental conditions determined experimentally or analytically. Based on the selected movement mode, the appropriate set of low-level primitives are activated to implement the high-level primitive.

As another example, movement modes may be selected adaptively, by the microprocessor 86 selecting a first movement mode and switching to a second movement mode if the first movement mode fails. For example, the environmental data 94 may indicate slippage, tilting, unstable pose, or other undesired conditions. This can cause a particular primitive to be automatically activated, such as a traction-increasing primitive, self-righting primitive, self-stabilizing primitive, etc.

The robotic crawler control system 80 can include means for executing the variable set of low level primitives to move the robotic crawler, for example drivers 96. The drivers provide output signals from the microprocessor to drive the various actuators, motors, etc. 98 of the robotic crawler to produce physical movements of the robotic crawler.

The examples provided so far have been relatively straightforward, but it should be appreciated that complex mappings can be used. For example, sensor data may be processed to determine effectiveness of the movement mode with respect to traction, power efficiency, noise generation, etc. Accordingly, the variable set of low-level primitives that are executed may be dynamically changing. Some low-level primitives may be activated for a while, and then deactivated later. Furthermore, some predefined primitives may be activated (and deactivated) automatically when predetermined environmental conditions are sensed. For example, mapping the high-level primitive into a variable set of low-level primitives can include executing a self-righting primitive when the environmental data indicates the robotic crawler is tipping over, a traction-increasing primitive when the robotic crawler is slipping, or a self-stabilizing primitive when the robotic crawler is in an unstable pose.

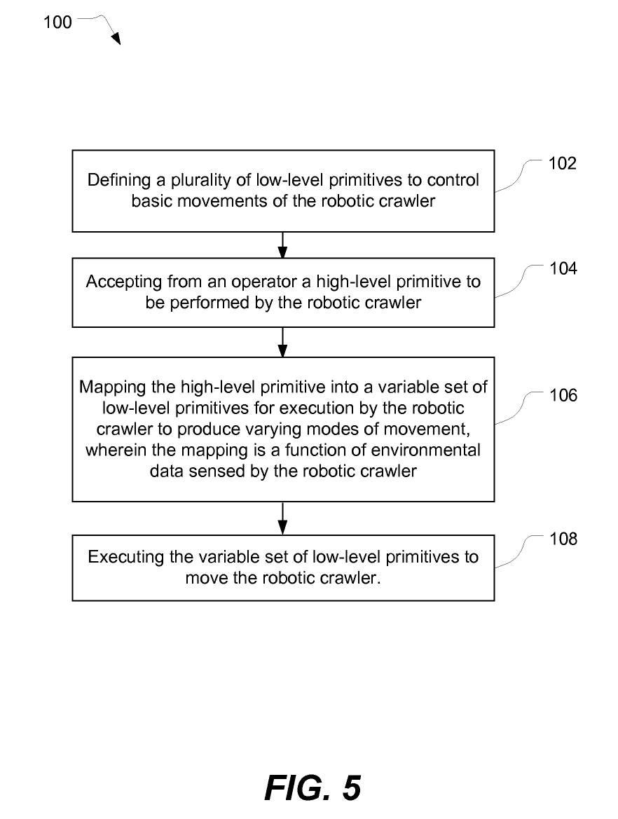

FIG. 5 illustrates a method of varying character of movement of a robotic crawler within an environment. The method 100 includes defining 102 a plurality of low-level primitives to control basic movements of the robotic crawler. For example, the low-level primitives may be defined by control circuits or software routines as described above. The method may also include accepting 104 from an operator a high-level primitive to be performed by the robotic crawler. For example, the high-level primitive may be communicated via an operator control console (e.g., a joystick) via a wired or wireless link to the robotic crawler as described above. The method may also include mapping 106 the high-level primitive into a variable set of low-level primitives for execution by the robotic crawler to produce varying modes of movement. The mapping can be a function of environmental data sensed by the robotic crawler. For example, the robotic crawler may include various sensors and processing to determine a desired pose and/or movement mode as described above. Finally, the method may include executing 108 the variable set of low-level primitives to move the robotic crawler.

Summarizing and reiterating to some extent, robotic control using embodiments of the present invention can improve the manageability of complex, highly capable robotic crawlers. While the robotic crawler may be capable of a wide variety of movement modes, detailed low-level primitive control of the movement modes can be mapped into high-level primitives that are controlled by the operator using a small number of intuitive inputs. The operator thus need not specify every detailed movement of the robotic crawler. When necessitated by environmental conditions, the robotic crawler can automatically adjust the movement mode, pose, or other aspects of its operation without requiring operator intervention and without requiring the operator to use different control techniques or different controls. Applications of the control techniques can include complex multi-jointed robotic crawlers used in search and rescue, military operations, and industrial operations.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present: a) “means for” or “step for” is expressly recited in that limitation; b) a corresponding function is expressly recited in that limitation; and c) structure, material or acts that support that function are described within the specification. Accordingly, the scope of the invention should be determined solely by the appended claims and their legal equivalents, rather than by the descriptions and examples given above.

What is claimed is:

1. A method for varying character of movement of a robotic crawler within an environment, comprising:
defining a plurality of low-level primitives to control basic movements of the robotic crawler;
accepting from an operator a high-level primitive to be performed by the robotic crawler;
mapping the high-level primitive into a variable set of low-level primitives for execution by the robotic crawler to produce varying modes of movement, wherein the mapping is a function of environmental data sensed by the robotic crawler; and
executing the variable set of low-level primitives to move the robotic crawler.

2. The method of claim 1, wherein defining a plurality of low-level primitives comprises defining a plurality of low-level primitives corresponding to particular poses of the robotic crawler.

3. The method of claim 1, wherein the means for mapping the variable set of low-level primitives comprises means for activating a predefined primitive when a predefined environmental condition is sensed.

4. The system of claim 1, wherein the means for mapping the variable set of low-level primitives comprises means for deactivating a predefined primitive when a predefined environmental condition is sensed.

5. The method of claim 1, wherein mapping the high-level primitive into a variable set of low-level primitives comprises:
switching from a first movement mode optimized for a first environment to a second movement mode optimized for a second, topographically different, environment when the robotic crawler moves from the first environment to the second environment.

6. The method of claim 5, wherein the first environment is a horizontal surface and the second environment is a vertical surface.

7. The method of claim 1, wherein mapping the high-level primitive into a variable set of low-level primitives comprises executing a self-righting primitive when the environmental data indicates the robotic crawler is tipping over.

8. The method of claim 1, wherein mapping the high-level primitive into a variable set of low-level primitives comprises executing a traction-increasing primitive when the environmental data indicates the robotic crawler is slipping.

9. The method of claim 1, wherein mapping the high-level primitive into a variable set of low-level primitives comprises executing a self-stabilizing primitive when the environmental data indicates the robotic crawler is in an unstable pose.

10. The method of claim 1, wherein mapping the high-level primitive into a variable set of low-level primitives comprises mapping a high-level movement primitive command into low-level primitives defining pose, traction and drive mode, wherein the pose, traction and drive mode are a function of the environmental data.

11. The method of claim 1, wherein mapping the high-level primitive into a variable set of low-level primitives comprises selecting a movement mode based on the environmental data and activating low-level primitives associated with the selected movement mode.

12. The method of claim 11, wherein selecting a movement mode based on the environmental data uses a predefined association of movement modes to particular environmental conditions.

13. The method of claim 11, wherein selecting a movement mode based on the environmental data comprises adaptively varying movement mode when the environmental data indicates undesired conditions.

14. A computer readable medium comprising computer readable program code to implement the method of claim 1.

15. A method for varying the character of movement of a robotic crawler within an environment, comprising:
defining a series of low-level primitives defining basic movements of the robotic crawler;
accepting an operator commanded high-level primitive for robotic crawler movement;
mapping the high-level primitive into a variable set of low-level primitives;
executing the low-level primitives to implement the high-level primitive operation to move the robotic crawler; and
varying the set of low-level primitives in response to environmental conditions sensed by the robotic crawler to adapt movement mode of the robotic crawler to the environment.

16. The method of claim 15, wherein mapping the high-level primitive into a variable set of low-level primitives comprises:
switching from a first movement mode optimized for a first environment to a second movement mode optimized for a second, topologically different, environment when the robotic crawler moves from the first environment to the second environment.

17. The method of claim 15, wherein mapping the high-level primitive into a variable set of low-level primitives comprises selecting a movement mode based on the environmental data and activating low-level primitives associated with the selected movement mode.

18. A robotic crawler control system capable of varying the character of movement within an environment, comprising:
means for sensing the environment in which the robotic crawler is operating to produce environmental data;
means for accepting from an operator a high-level primitive to be performed by the robotic crawler;
means for mapping the high level primitive into a variable set of low-level primitives for execution by the robotic crawler to produce varying modes of movement, wherein the mapping is a function of the environmental data; and
means for executing the variable set of low-level primitives to move the robotic crawler.

19. The system of claim 18, wherein the plurality of low-level primitives comprises low-level primitives corresponding to particular poses of the robotic crawler.

20. The system of claim 18, wherein the plurality of low-level primitives comprises low-level primitives corresponding to basic movements of the robotic crawler.

21. The system of claim 18, wherein the means for mapping the high-level primitive into a variable set of low-level primitives comprises means for switching from a first movement mode optimized for a first environment to a second movement mode optimized for a second, topologically different, environment when the robotic crawler moves from the first environment to the second environment.

22. A robotic crawler control system comprising:
a robotic crawler having a plurality of joints driven by a plurality of actuators and at least one sensor;
a microprocessor coupled to the plurality of actuators through a plurality of drivers to enable microprocessor control of the actuators;
a command interface configured to accept operator input high-level primitive commands and communicate the high-level primitive commands to the microprocessor; and
a mapper implemented in computer readable instructions executable on the microprocessor to cause the microprocessor to map the high-level primitive commands into a variable set of low-level primitives which execute to produce signals to the drivers to produce varying modes of movement for the robotic crawler.

23. The robotic crawler control system of claim 22 wherein the command interface is a wired link or a wireless link.

24. The robotic crawler control system of claim 22, wherein the sensor is chosen from the group of sensors consisting of a camera, a chemical sensor, a biological sensor, an optical sensor, a moisture sensor, a vibration sensor, a temperature sensor, an electromagnetic sensor, a sound sensor, a force sensor, a sonar sensor, a radar sensor, a lidar sensor, a radioactive isotope sensor, a seismic sensor, a pressure sensor, a magnetometer, a sampling sensor, an orientation sensor, an inertial measurement unit, a joint torque sensor, a joint position sensor, or combinations thereof.

25. The robotic crawler control system of claim 22, wherein the mapper is further configured to select a movement mode based on the environmental data and to activate low-level primitives associated with the selected movement mode

26. The robotic crawler control system of claim 22, wherein the mapper comprises a predefined association of a plurality of movement modes to a plurality of environmental conditions.
